(19) United States
(12) Patent Application Publication
(10) Pub. No.: US 2007/0033623 A1
(43) Pub. Date: Feb. 8, 2007

(54) Method and apparatus for providing continuous programming on a broadcast channel

(75) Inventors: James Martin Fredrickson, Princeton, NJ (US); Jesse Samuel Lerman, Cranbury, NJ (US); Paul Andrews, Titusville, NJ (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Princeton Server Group, Inc., Princeton, NJ (US)

(21) Appl. No.: 11/499,845

(22) Filed: Aug. 4, 2006

Related U.S. Application Data
(60) Provisional application No. 60/705,761, filed on Aug. 5, 2005.

(51) Int. Cl. H04N 7/173

(52) U.S. Cl. 725/88; 725/94; 725/102

(57) ABSTRACT

A method and apparatus for automatically providing continuous programming on a broadcast channel. The method and apparatus detect the occurrence of an event, selects content to use as the continuity programming in view of at least one characteristic of the event, and transmits the selected content through the broadcast channel.

### CROSS-REFERENCE TO RELATED APPLICATIONS

This application claims benefit of U.S. provisional patent application Ser. No. 60/705,761, filed Aug. 5, 2005, which is herein incorporated by reference.

### BACKGROUND OF THE INVENTION

1. Field of the Invention

Embodiments of the present invention generally relate to systems for broadcasting video through a broadcast channel and, more particularly, to a method and apparatus for providing continuous programming on a broadcast channel.

2. Description of the Related Art

Broadcasters generally program content to be transmitted on a channel such that a channel can be occupied with video information 24 hours a day, seven days a week. In many cases programming starts on boundaries such as “on the hour” or “on the half-hour”. However, when programming does not end perfectly on the hour or half-hour such as a 25 minute program in a half-hour block of time, it can be laborious and costly to make sure filling content fits exactly between the end of the program and the beginning of the next program.

Therefore, there is a need in the art for a method and apparatus for automatically filling content gaps to create continuous programming at a reduced operational cost to broadcasters.

### SUMMARY OF THE INVENTION

The present invention is a method and apparatus for automatically providing continuous programming on a broadcast channel. The method and apparatus detect the occurrence of an event, select content to use as the continuity programming in view of at least one characteristic of the event, and transmit the selected content through the broadcast channel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The teachings of the present invention can be readily understood by considering the following detailed description in conjunction with the accompanying drawings, in which:

FIG. 1 is a block diagram of a system capable of providing continuous programming for a broadcast media channel;

FIG. 2 is a flow diagram of the process of a method of operation for a broadcast controller in accordance with one embodiment of the invention;

FIG. 3 is a flow diagram of a method of operation for a scheduler in accordance with one embodiment of the invention;

FIG. 4 is a flow diagram of a method of operation for a dispatcher in accordance with one embodiment of the invention;

FIG. 5 is an exemplary schedule node stack utilized by the present invention; and

FIG. 6 is a representation of a continuity scenario that can be implemented by one embodiment of the invention.

### DETAILED DESCRIPTION

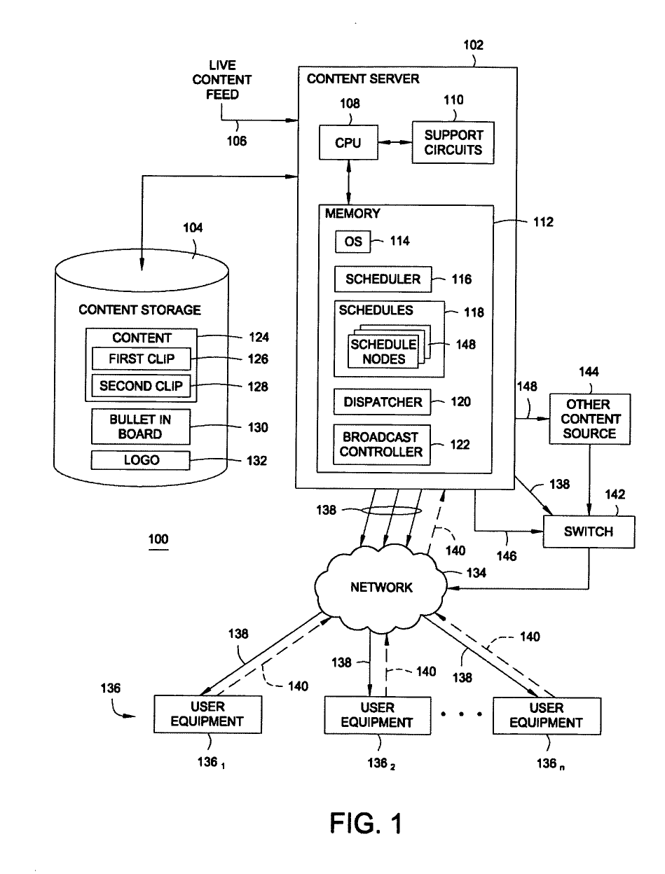

FIG. 1 depicts a block diagram of a system 100 for providing multimedia content, e.g., video, at least one channel to be viewed by users. The system 100 comprises a content server 102, content storage 104, a network 134, and user equipment 136₁, 136₂, . . . 136ₙ (collectively referred to herein as user equipment 136). The content server 102 schedules and organizes program transmissions that are continuously delivered on at least one broadcast channel 138 for viewing by the users.

The content server 102 comprises a central processing unit (CPU) 108, support circuits 110, and memory 112. The central processing unit 108 may comprise one or more commercially available microprocessors or microcontrollers. The support circuits 110 are designed to support the operation of the CPU 108 and facilitate delivery of content to the broadcast channels 138. The support circuits 110 comprise such well known circuits as cache, power supplies, clock circuits, input/output circuitry, network interface cards, video encoders/decoders, quadrature amplitude modulation (QAM) modulators, content buffers, storage interface cards, and the like. The memory 112 may be any one of a number of digital storage memories used to provide executable software and data to the CPU 108. Such memory includes random access memory, read only memory, disc drive memory, removable storage, optical storage, and the like. The memory 112 comprises an operating system (OS) 114, a scheduler 116, schedules 118, a dispatcher 120, and a broadcast controller 122. The OS 114 may be any one of the operating systems available including MICROSOFT WINDOWS, LINUX, AS400, OSX, and the like. The other modules operate to provide continuous programming in accordance with the invention. Each of the executable software modules are discussed below.

The server 102 is coupled to a video storage unit 104, which may be any form of bulk digital storage and/or analog storage for storing multimedia content. The content storage 104 stores, for example, content clips 124, including a first clip 126 and a second clip 128, bulletin board information 130 and logos 132. The content from the content storage 104 is accessed by the server 102 and transmitted at appropriate times. Programming is transmitted by the broadcast controller until an event occurs. Upon the occurrence of an event, the scheduler 116 selects content to use as continuity programming. Depending upon the characteristics of the event, the selected content may be used to fill a gap in programming or may be used to provide an overlay “over” the programming such as for “weather on the 5s” or “now playing/next playing” announcements. The selected content is broadcast on at least one channel 138.

In addition to the stored content, the video server may accept a live content feed 106 and transmit the information via the channels 138 at appropriate times. The live feed may be an analog feed that is converted into a digital signal, or the live feed may be an analog or digital feed that is directly coupled to the one or more channels 138, such as via a video switcher under control by the broadcast controller and scheduler. The channels 138 propagate the content through the network 134 to user equipment 136₁, 136₂, . . . 136ₙ. In a broadcast configuration, the channels 138 are coupled to one or more of the user equipment 136 such that a user can view the content on their television or computer monitor. The user equipment 136 may comprise a set top box for decoding the information supplied by the server. To facilitate viewing of the content, the set top box may be coupled to a television or other display unit. Alternatively, the user equipment 136 may be a computer that is capable of decoding the video content and displaying that information to the user.

In one embodiment of the invention, the server 102 is used to broadcast information to the users in a uni-directional manner through the channels, through the network 134, to the user equipment 136. The user equipment 136 selects a channel to decode and view. Such a broadcast may use multicast IP addresses that can be “tuned” by the user equipment 136 to select programming for viewing.

In another embodiment of the invention, the user equipment 136 may request particular information, such as in a video-on-demand (VOD) type system or a browser based system. The dashed arrow 140 in FIG. 1 represents a “back channel”. This back channel is used for requesting specific video or other content to be delivered to the user equipment 136 via the channels 138. In this embodiment, the broadcast controller 122 will accept the request, then access the requested content and deliver that content on a specific channel (and/or using a specific address) to the user equipment 136.

To continuously program content for delivery to users, the broadcast controller 122 interacts with the dispatcher 116 and the scheduler to provide content to the users. Specific content 124 is scheduled and streamed through the channels to the users. The content comprises non-continuity programming and continuity programming. Generally, the server 102 transmits non-continuity programming (e.g., a television program or movie) in accordance with a schedule or playlist. Upon occurrence of an event such as the end of the program, a preemption event, a time event, and the like, continuity programming will be supplied as defined by a characteristic of the event. For example, at times when the non-continuity programming is not available, has ended or other events have occurred, the broadcast controller 122 utilizes the scheduler 116 and the dispatcher 120 to identify continuity programming to fill the gaps in the broadcast.

In one embodiment of the invention, continuity programming is used upon an occurrence of a first type of continuity event, i.e., play when no other programming is scheduled. The continuity programming loops upon completion, and automatically ends when a program is ready to play. Continuity programming can either restart each time it is triggered, resume where it left off, or resume at the start of the next play list item in the case of continuity being a play list.

In another embodiment of the invention, a second type of continuity event, such as a message or trigger causes a switch 142 to allow another device or process (other content source 144) to send content to a broadcast channel 138. Examples are a command sent along path 146 to a video switch 142 to switch the broadcast channel from the server 102 to a graphics generator or a bulletin board (other sources 144). When a scheduled program is ready to air, a return command can be sent via path 146 to the switch to switch 142 back to the server 102. In the case of a triggering event, a switch event to allow another device to gain access to the output channel, the video server supports a mechanism (path 148) for telling the external device when it is ready to return to programming so the external device can optionally bookmark where it left off to resume at a later time, i.e., at the next continuity event. The server also supports obtaining the bookmark for the next trigger in case the external device does not have a persistent memory.

In yet another embodiment of the invention, continuity programming is non-video programming such as a sequence of JPEG images internally controlled by the server 102, or other multimedia content that can be transmitted via the channel, for example, using a video card frame buffer. Such internally generated content includes text crawls, graphics, motion graphics, and the like. These continuity programming types may be mixed with other continuity content such as slow motion video. Additional, internally controlled continuity programming includes video, images, text, and other forms of programming that can be auto generated and scheduled. Further examples are scrolling program guide announcing the upcoming program schedule, time and temperature, real time sports updates, and the like. Using techniques such as on-the-fly video encoding and real-time graphics generation, sophisticated and informative continuity programming can be intelligently and appropriately generated on-the-fly by the content server 102. For example, a program guide can be created from schedule metadata within a schedule 118 for either display as a sequence of JPEG's, or as full motion video or a flash movie.

Continuity content may also be schedule based on date and time for programming. The use of a schedule generates triggering events in accordance with the schedule. For example, at 8:00 p.m., on a specific date in the future, a triggering event will occur and cause continuity programming defined to be a video clip A to be transmitted. At 9:00 p.m., on that date, continuity programming that is created in response to another event is routed from an external source 144. Every Monday, Wednesday, and Friday at 2:00 p.m. continuity programming may be a play list of JPEG's, flash images, and video clips. These examples capture the concept and, of course, many variations may be applied.

The scheduled continuity objects are one form of rule-based continuity. The continuity objects may be of long form or short form. The long form continuity programming could be defined when a gap exists of more than a single time period, such as one minute. In this case, a video clip can be defined as continuity programming or a switch even can be triggered to cut over to a bulletin board system. Short form continuity could be defined when a gap exists of less than a time period, such as one minute. In this case, a simple station identifier logo can be displayed. Long and short form continuity programming are intended as a practical example of rules based continuity.

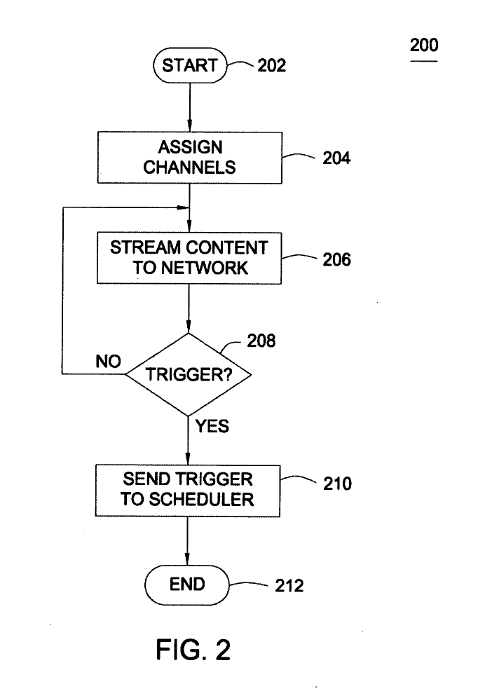

FIG. 2 depicts a flow diagram of a method 200 of operation of the broadcast controller 122. The method 200 begins at step 202 and proceeds to step 204, where at least one channel is assigned for particular programs. At step 206, video or other content is streamed to the network on the assigned channels. On an interrupt basis, the stream may end and form a triggering event. If a triggering event is not recognized at step 208, the method 200 follows path 214 to return to block 206 to continue streaming content to the network on the assigned channels. If at step 208, a triggering event is detected, then the method 200 proceeds to step 210, where a trigger is created and sent to the scheduler 116. At that point, the broadcast controller ends at step 212 and the scheduler 116 administers the process of accessing and sending continuity programming to users.

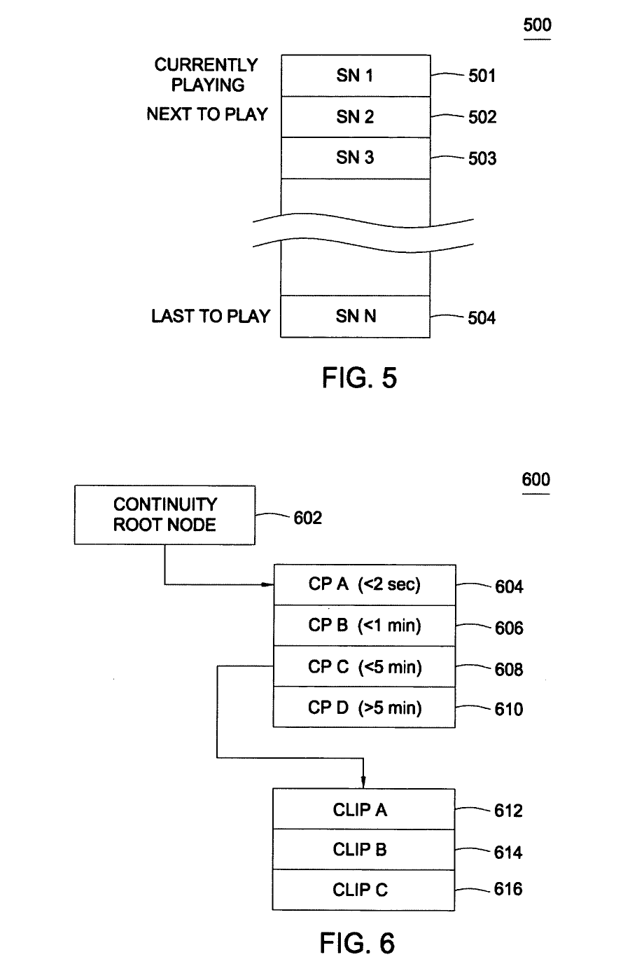

The scheduler 116 calls the dispatcher 120. The dispatcher 120 organizes the continuity programming for transmission. The organization is facilitated by a schedule 118 that comprises a plurality of schedule nodes 148. FIG. 5 depicts one example of a schedule 500 comprising schedule nodes 501, 502, 503, and 504 that are arranged in the order (top to bottom) in which they will be played. The trigger that starts each schedule node may be a particular event such as the end of a program, or the trigger may be a specific time when continuity programming is to be transmitted.

The continuity programming may be a “continuity clip”, i.e., any content selection such as video, graphics, logo, bulletin board, and the like, that is inserted as a “gap filler”. Alternatively, the continuity programming may be an “auto overlay”. The “auto overlay” is a graphic that is triggered to appear “over” the current programming (non-continuity programming) being viewed by a user.

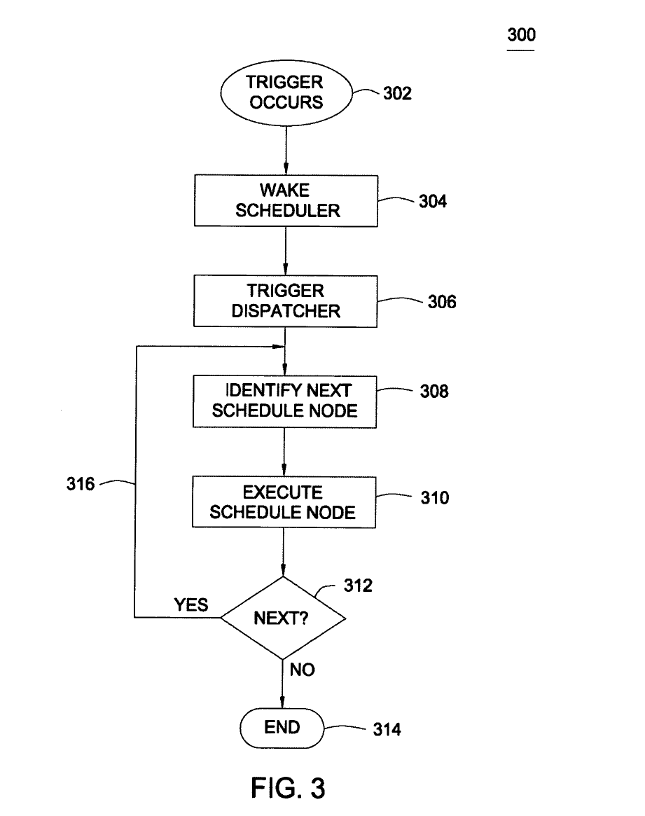

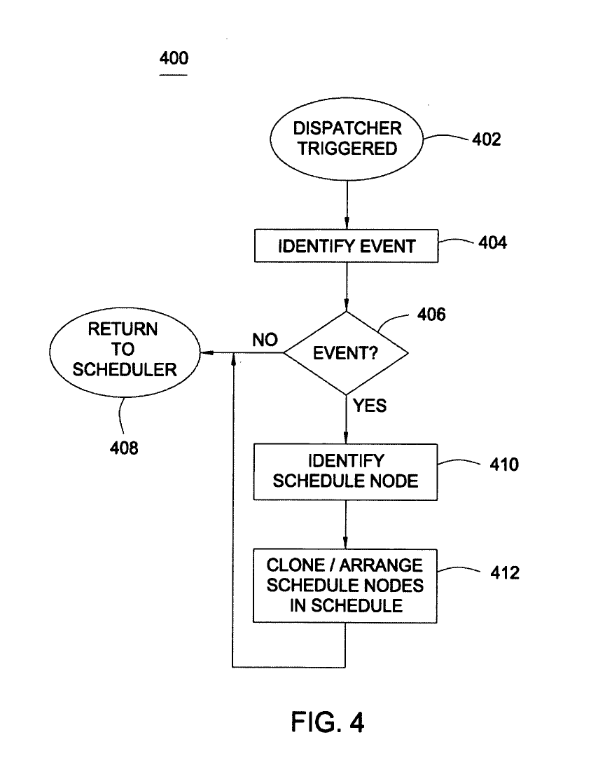

FIG. 3 depicts a method 300 of the operation of the scheduler 116. At step 302 a trigger (event or time) has been detected by the broadcast controller 122, which causes the scheduler 116 to be executed at step 304. At step 306, the method 300 triggers the dispatcher 120, which is discussed with respect to FIG. 4 below. At step 308, the method 300 identifies the next schedule node 148 to be utilized for creating programming to fill a gap in or create an overlay for the programs being displayed by the broadcast controller 122. The schedule nodes 148 are organized in a stack, where the next schedule node to be used for scheduling continuity programming is generally positioned at the top of the stack by the dispatcher 120. A schedule node defines a file name or source for the programming to be scheduled, the start time for the action, any starting offset that may be used, the duration of one instant of the action, a period between multiple instances (if any), total life time of multiple instances (if any), various flags denoting special behavior, a priority flag to indicate the priority of the scheduled action, an event (if any) that triggers the action of the schedule node, an event state (if any) that triggers the action of the schedule node, a database ID of an event (if any) that triggers the action, a flag denoting that the action is a continuity action, a flag that denotes the action is active, i.e., playing, a pointer to the next schedule in the stack, and a pointer to the previous schedule in the stack.

The schedule node may also identify a source to be used to supply content. For example, the source of information could be an RSS feed (i.e., syndicated multimedia feed from the Internet) that is identified by its metadata. In this case continuity is a rule as opposed to referencing actual content. For example, continuity could be “the most recently published clip from RSS feed XYZ” or “most recent clip from a collection of RSS feeds that are about sports”. To find such clips using a rule, the metadata from the RSS feed is checked, and when a match is found, that clip is downloaded for playout as the continuity content.

The pseudo-code for a schedule node is recited below:

```
ScheduleNode
{
  name  // Filename or string identifying this action
  dataBaseId  // Database Id of this action
  msecStart  // Scheduled start time of this action (since 12:00AM
  01/01/70)
  msecOffset  // Starting offset (if any) within an action of duration > 0
  msecDuration // Duration of one instance of this action
  msecPeriod  // Period between multiple instances (if any) of this action
  msecLifetime // Total lifetime of multiple instances (if any)
  attributes  // Bit flags denoting special behavior
  priority  // Priority of this scheduled action
  trigEvent  // Event (if any) that triggers this action
  trigState  // Event state (if any) that triggers this action
  trigDbid  // Database Id of event (if any) that triggers this action
  isContinuity // Flag that denotes this action as “continuity”
  isActive  // Flag that denotes this action as “active” (playing)
  list  // Pointer to another schedule list (if any)
  next  // Pointer to the next schedule in the stack (NULL if none)
  last  // Pointer to the previous schedule in the stack (NULL if none)
}
```

The following entries influence the position of the schedule node within the schedule node stack:
MsecStart Is the usual key which specifies the sorted order of the list.
msecPeriod Specifies that the schedule, after it has been triggered, will be reinserted back into the list at time (msecStart+msecPeriod). (Recurrence)
trigEvent Specifies an event (e.g. PLAYOUT) that will push this node back into the stack as a true scheduled event. (auto overlay)
trigState Specifies the state of the trigEvent that triggers the push into the stack (e.g. STARTED).
isContinuity Specifies that this schedule is always at the top of the list as long as nothing else overrules it.

At step 310, the scheduler executes the identified schedule node. By doing so, the continuity programming is transmitted to the network on the assigned broadcast channel. The method 300 continues to identify the next schedule node and execute the schedule node at steps 308 and 310 until a non-continuity indicator occurs that causes the broadcast controller 122 to begin broadcasting the next non-continuity content such as a main program. This loop is represented by the query at step 312 regarding whether the next schedule shall be executed. If the next schedule node in the schedule is to be executed, the method 300 returns to step 308 to identify the next schedule node, then executes that schedule node at step 310. This loop will repeat until no further schedule nodes are in the schedule or the broadcast controller is to use the channel for broadcasting. The method 300 ends at step 314.

The scheduler can be represented in pseudo-code as follows:

```
scheduler( )
{
  timeout = MAX_TIMEOUT;
  for (;;) {
    poll(events, numEvents, timeout); // Wait for an event or timeout
    timeout = MAX_TIMEOUT;
    for (channel = 0; channel < numChannels; channel++) {
      ScheduleNode *nextNode = NULL; // Next node to trigger (if any)
      ScheduleNode *currNode = NULL; // Current active node (if any)
      ScheduleNode *contNode = NULL; // Continuity node  (if any)
      ScheduleNode *schedule = NULL; // Pointer to a schedule in the stack
      // Search through the schedule stack looking for the next schedule
      // node to be triggered (should be first non-active non-continuity
      // schedule). Also note that active and continuity schedules will
      // be found first (if any exist).
      schedule = scheduleStack[channel]->top;
      while ((schedule != NULL) && (nextNode == NULL)) {
        if ((!schedule->isActive) && (!schedule->isContinuity)) {
          nextNode = schedule;
        } else {
          if (schedule->isActive)  currNode = schedule;
          if (schedule->isContinuity) contNode = schedule;□
        }
          schedule = schedule->next;
        }
        // Was a pending schedule found?
        if (nextNode != NULL) {
          // Is this a new continuity node?
          if (nextNode->attributes & NEW_CONTINUITY) {
            // Yes, free current continuity and replace with new one
            freeSchedule(contNode);
            nextNode->attributes \hat{ }= NEW_CONTINUITY;
            nextNode->attributes |= CONTINUITY;
            insertSchedule(scheduleStack[channel], nextNode);
          } else {
            // No, it is a pending schedule. Is it ready now?
            if (nextNode->msecStart <= currTime( )) {
              // It is ready now. Is anything else active?
              if (currNode != NULL) {
                // Something else is active. Can it be preempted?
                if (nextNode->priority > currNode->priority) {
                  // It can be preempted. Stop it and start new schedule.
                  stopSchedule(currNode);
                  startSchedule(nextNode);
                } else {
                  // Can't be preempted. Can skip? Otherwise postpone.
                  if (nextNode->attributes & CAN_SKIP) {
                    // Yes, can skip. Free it.
                    freeSchedule(nextNode);
                  }
                }
              } else {
                // Nothing active. Start new schedule.
                startSchedule(nextNode);
              }
            } else {
              // New schedule not ready yet. Update poll timeout.
              if (nextNode->msecStart < timeout) {
                timeout = nextNode->msecStart;
              }
              // If a continuity schedule exists, then process it.
              if (contNode != NULL) {
                timeRemaining = nextNode->msecStart − currTime( );
                processContinuity(contNode, timeRemaining);
              }
            }
          }
        } else {
        // Did not find pending schedule.
        // If a continuity schedule exists, then process it.
        if (contNode != NULL) processContinuity(contNode, MAX_UINT64);
      }
    }
  }
}
```

The pseudo-code for the processContinuity function is as follows:

```
processContinuity(ScheduleNode *continuity, uint64 timeRemaining)
{
  Schedule *schedule;
  // Is this a root continuity node?
  if (continuity->list != NULL) {
    // Yes, traverse list looking for appropriate window
    schedule = continuity->list->top;
    while (schedule != NULL) {
      if (timeRemaining < schedule->msecWindow) break;
      schedule = schedule->next;
    }
    // Found appropriate continuity clip?
    if (schedule != NULL) {
      // Is this a switch command?
      if (schedule->attributes & SWITCH_COMMAND) {
        // Are we in home position?
        if (streamNode->inHomePosition) {
          // Yes, execute switch
          executeSwitchCmd(schedule);
        }
      } else {
        // No, just a simple clip (start it)
        startSchedule(schedule);
      }
    }
  } else {
    // No, just a simple schedule. Is this a switch command?
    if (continuity->attributes & SWITCH_COMMAND) {
      // Are we in home position?
      if (streamNode->inHomePosition) {
        // Yes, execute switch
        executeSwitchCmd(continuity);
      }
    } else {
      // No, just a simple clip (start it)
      startSchedule(continuity);
    }
  }
}
```

The functions “start schedule” and “stop schedule” within the pseudo-code of the scheduler cause the dispatcher to wake up and perform a designated action. FIG. 4 depicts a flow diagram of a method 400 of the operation of the dispatcher 120. At step 402, the dispatcher 120 is triggered by the scheduler (FIG. 3). At step 404, the method 400 identifies an event that has triggered the scheduler. At step 406, if the event is a null event, the method 400 returns to the scheduler (step 408). If the event requires an action by the dispatcher, the query at step 406 is affirmatively answered and the method 400 proceeds to step 410. At step 410, the method 400 identifies a particular schedule node that is required to run in view of at least one characteristic of the event. Furthermore, an event may indicate a state of another specific event, where such an event may comprises at least one of started, terminated, completed, failed, resumed, postponed, preempted, skipped, missed, or the state of a class events such as playout, capture, overlay, device trigger, and video switch. At step 412, the dispatcher either clones the identified schedule node or arranges the schedule nodes in the stack in such a way that the schedule node at the top of the stack that will be executed next responds to the required event with an action that is appropriate for that event. At step 414, the method 400 returns to the scheduler where the schedule node at the top of the schedule stack will be executed.

The pseudocode for the operation of the dispatcher is as follows;

```
dispatcher( )
{
  ScheduleNode *schedule;
  for (;;) {
    poll(events, numEvents, 0); // Wait for an event
    // Fetch event and act upon it.
    switch (fetchEvent( )) {
      case START:
        // Fetch new schedule.
        schedule = fetchCurrentSchedule( );
        // Start new schedule.
        start(schedule);
        // Call notifier in case this event triggers another
        eventNotify(channel, schedule, schedule->attributes,
        STARTED);
        break;
      case COMPLETED:
        // Completed: Call notifier in case this event triggers another
        eventNotify(channel, schedule, schedule->attributes,
        COMPLETED);
        freeSchedule(schedule);
        break;
      case TERMINATE:
        // Terminate current schedule
        terminate(schedule);
        // Terminated: Call notifier in case this event triggers another
        eventNotify(channel, schedule, schedule->attributes,
        TERMINATED);
        freeSchedule(schedule);
        break;
      case FAILED:
        // Failed: Call notifier in case this event triggers another
        eventNotify(channel, schedule, schedule->attributes, FAILED);
        freeSchedule(schedule);
      break;
      default: {
      }
    }
  }
}
```

The dispatcher calls an eventNotify function for any event that the dispatcher is to perform. The eventNotify function searches the list of schedule nodes for any that are triggered by the current event. The pseudo-code for the eventNotify function is as follows:

```
eventNotify(int channel, ScheduleNode *schedule, int event, int state)
{
  // Search for trigger event (start at top)
  ScheduleNode *trigger = scheduleStack[channel]->top;
  // Search list for matching trigger event
  while (trigger != NULL) {
    if (trigger->trigEvent & event) {
      if (trigger->trigState & state) {
        if (trigger->trigDbid == ANY_ID) break;
        if (trigger->trigDbid == schedule->dataBaseId) break;
      }
    }
    trigger = trigger->next;
  }
  // Found one?
  if (trigger != NULL) {
    // Yes, clone trigger event as an actual (to run) instance of itself.
    cloneSchedule(channel, trigger);
  } else {
    // No, is the current schedule recurrent?
    if ((state == STARTED) && schedule->msecPeriod) {
      // Yes, clone schedule as yet another future instance of itself
      cloneSchedule(channel, schedule);
    }
  }
}
```

The cloneSchedule function, which is performed by the dispatcher, creates copies of schedules, modifies them appropriately, and inserts them into the schedule node stack. The scheduler, in turn, processes them accordingly. The cloneSchedule function pseudocode is as follows;

```
cloneSchedule(int channel, ScheduleNode *schedule)
{
  // Is this schedule still alive? (msecLifetime == 0 lasts forever)
  if (!schedule->msecLifetime || schedule->msecLifetime > currTime( )) {
    // Yes, still alive. Clone it.
    ScheduleNode *clone = getFreeSchedule( );
    memcpy(clone, schedule, sizeof(ScheduleNode));
    // Don't clone recurrent attributes (clear them)
    clone->trigEvent = NULL_EVENT;
    clone->trigState = NULL_STATE;
    // Set start time for clone (msecStart treated as relative to present)
    clone->msecStart = currTime( ) + schedule->msecStart;
    // Insert it into stack and awaken scheduler
    insertSchedule(scheduleStack[channel], clone);
    eventNotify(channel, schedule, schedule->attributes, SCHEDULED);
    wakeScheduler( );
  }
}
```

FIG. 5 depicts a representation of a schedule node stack 500 wherein a schedule node (SN1) 501 that is currently being played is at the top of the stack. The schedule node (SN2) 502 that is second in the stack is next to play, schedule node (SN3) 503 is next, and so on down to schedule node N at 504, which is the last to play in this schedule node stack 500. The group of schedule nodes within the schedule node stack define a schedule or playlistthat is to be streamed from the server. Continuity programming schedule nodes would generally reside at the top of the stack and would be streamed upon an event occurring in which continuity program is needed to fill a gap in or provide an overlay for the usual broadcast programming. In this manner, the user is presented with a continuous stream of information without breaks or gaps. Furthermore the entire process of filling the gaps is automated such that once programmed an operator does not have to be controlling the streaming of gapped filling continuity programming.

Schedules may be nested to create a “playlist” that forms a continuity list. A continuity list contains a number of schedules that call other schedules, where each continuity program may be used to fill gaps of various lengths. For example, the scheduler is driven primarily by a timer (based on the nearest time something is scheduled to start) or an event (something completed/failed or another thread woke it up). When the Scheduler is awaken, it checks the scheduleNode stack for each channel to determine if a new schedule is to be started. If the top of the stack is “continuity” it will continue down the list until it finds a non-continuity node. If that node is ready (msecStart<=currTime( )), then that schedule is started, if not, the continuity node (if any) is started. If something is already active, the priority field is used to determine if the current schedule should be preempted and replaced by the new. If not, the new schedule may be postponed or entirely skipped based on attributes set when scheduled. Any individual schedule node can, in turn, be the root node of yet another list of schedule nodes. This is useful to implement the concept of a “playlist” which is a collection of individual entities that are meant to be treated as a whole. When such a schedule node is started, its list is then traversed, one node after another, until exhausted (it may start over again if the root node also happens to be a continuity node). A continuity root node can also contain a list of other continuity nodes (some of which may be other lists). Continuity also supports the concept of a “continuity window” which specifies different continuity events to play based upon how much dead time exists before the next actual schedule starts.

As an example, consider the continuity scenario 600 in FIG. 6. The Continuity Root Node 602 points to a list of continuity nodes: Continuity A 604 is played when less than 2 seconds, for example, remain before the next schedule (a station logo perhaps), Continuity B 606 is played when less than 1 minute remains (station promo loop), Continuity C 608 is a playlist of 3 clips 612, 614 and 616 that are played when less than 5 minutes remain (list of commercials), Continuity D 610 is triggered when more than 5 minutes remain (video switch event to another source perhaps). Switch continuity is a continuity instance where the server output is entirely switched away from the output of the server (to a tape deck or powerpoint slideshow, for example). The switch occurs whenever nothing is playing or scheduled from the server. An additional constraint that the switch is currently set to the server “home port” position for the given channel may also be applied. The “home port” position for a channel is defined to be the normal playout position for server playout. The reason for this is that the switch could have been scheduled to be in some other position deliberately (don't want to move it from that position just because nothing is playing out of a non-viewed port). Anytime something else is scheduled for playout, of course, the switch must be returned to home.

Continuity playlists and schedules may also be automatically generated based on rules related to content type such as category, topic, duration (i.e. to fill a specific gap as best as possible) and other metadata including producer, sponsor, contributor, number of allowable play times. As such, the continuity features can be used to automatically run a TV channel based on preset rules. A broadcast server employing this technique could subscribe to RSS feeds for example and automatically download and play media enclosures from a variety of sources to either fill program gaps or run a continuous channel.

While the foregoing is directed to embodiments of the present invention, other and further embodiments of the invention may be devised without departing from the basic scope thereof, and the scope thereof is determined by the claims that follow

What is claimed is:

1. A method of creating continuous programming comprising:
detecting an event;
selecting content based on at least one characteristic of the event; and
transmitting the selected content through a broadcast channel.

2. The method of claim 1 wherein the event is a time event.

3. The method of claim 1 wherein the event indicates an end or failure of a currently playing content or event.

4. The method of claim 1 wherein the event indicates a state of another specific event comprising at least one of started, terminated, completed, failed, resumed, postponed, preempted, skipped, and missed.

5. The method of claim 1 wherein the event indicates a state of a class event comprising playout, capture, overlay, device trigger, and video switch.

6. The method of claim 1 wherein the at least one characteristic indicates a duration of content necessary to fill a gap between programs.

7. The method of claim 6 wherein content loops until the gap is filled.

8. The method of claim 1 wherein the content comprises at least one of a logo, a video clip, a web-page, a graphical image, a series of still images, a video switch event, an external device trigger, or a combination thereof.

9. The method of claim 1 further comprising transmitting continuous programming, where each program that forms the continuous programming comprises an associated priority and each program can be preempted by other programming of a different priority.

10. The method of claim 1 wherein the content has an associated offset and duration.

11. The method of claim 1 wherein the content is selected using a schedule.

12. The method of claim 11 wherein a plurality of schedule nodes within the schedule are arranged upon the trigger being detected.

13. The method of claim 11 wherein the schedule comprises a stack of schedule nodes that are arrangeed in sequential order.

14. The method of claim 13 wherein each schedule node defines the content that is used during the execution of the schedule node.

15. The method of claim 1 wherein the content is transmitted as a program through a broadcast channel.

16. The method of claim 1 wherein the content is transmitted as an overlay upon a program being transmitted through the broadcast channel.

17. The method of claim 1 wherein the content comprises at least one RSS feed, and the method further comprises:
identifying the content from the at least one RSS feed using metadata; and
downloading the identified content.

18. A method of generating continuous programming through a broadcast channel comprising:
transmitting programming in accordance with a schedule;
detecting an event having at least one characteristic;
selecting content based upon the at least one characteristic; and
transmitting the content in lieu of or as an overlay upon the programming.

19. Apparatus for generating continuity programming for transmission through a broadcast channel comprising:
a scheduler for determining content to transmit upon occurrence of an event, where the content is transmitted through the broadcast channel as an overlay or a program.

20. The apparatus of claim 19 further comprising a dispatcher, coupled to the scheduler, for organizing schedule nodes that identify content for use in continuity programming.

21. The apparatus of claim 19 wherein the schedule nodes are arranged into a schedule.

22. The apparatus of claim 19 further comprising a switch, coupled to the scheduler, that couples the content to the broadcast channel as directed by the scheduler.

23. The apparatus of claim 19 further comprising a broadcast controller for controlling transmission of programming through the broadcast channel and for generating the event.
